(19) United States
(12) Patent Application Publication
(10) Pub. No.: US 2024/0252955 A1
(43) Pub. Date: Aug. 1, 2024

(54) METHOD AND SYSTEM FOR PURIFICATION OF OIL

(71) Applicant: SKF MFR TECHNOLOGY AB, Stockholm (SE)

(72) Inventor: Lasse HURNASTI, Huddinge (SE)

(21) Appl. No.: 18/560,501

(22) PCT Filed: Jun. 2, 2021
(86) PCT No.: PCT/EP2021/064801

§ 371 Date: Nov. 13, 2023

(51) Int. Cl. B01D 17/02; B01D 21/04

(52) U.S. Cl. CPC B01D 17/0217; B01D 21/12

(57) ABSTRACT

The method comprises the steps of: —providing contaminated oil into a mixing system (3) comprising at least two mixers (5a, 5b, 5c) connected in parallel and at least one valve (6a, 6b, 6c) which can be controlled for allowing contaminated oil to enter one or more of the mixers (5a, 5b, 5c); —mixing the contaminated oil in the mixing system (3) wherein the step of mixing comprises measuring a pressure difference over at least one of the mixers (5a, 5b, 5c) and/or over the complete mixing system (3); and controlling the at least one valve (6a, 6b, 6c) in the mixing system (3) such that the contaminated oil is allowed to enter one or more of the mixers (5a, 5b, 5c) in dependence of the measured pressure difference.

### TECHNICAL FIELD OF THE INVENTION

The present invention relates to a method and a system for purification of oil.

### BACKGROUND OF THE INVENTION

Purification of oils, such as for example slop oil, waste oil, slurry oil, crude oil, industrial oil, petroleum products or bio-oils is important for the possibility to use/reuse oils and therefore an important factor for the environmental future and the limited nature resources of oils. Purification of slop oil (and waste oil, hereafter only referred to as slop oil) is problematic in many ways. Slop oil can comprise oil, water, particles and emulsion phase. The particles can stabilize the emulsion phase and complicate a purification process. Purification of industrial emulsions comprising water and oil, such as for example cutting fluids is also an important environmental issue.

In slop oil treatment, centrifuge systems are often used for example for separation of oil and water. Slop oils comprise different ingredients, such as different types of oils, water and particles, in different amounts. Hereby a composition of the slop oil will differ between each batch of slop oil to be purified. For example, a density and a viscosity of the oil in the slop oil will differ between different slop oils. Different types of oils may be present in the slop oil in different ratios and the different oils may have different viscosities. Hereby treatment conditions are very different for all batches of slop oil to be purified. This may be the case also for other types of oil to be purified, such as different types of industrial oils. A good purification result will not be achieved when different contaminated oils, such as different batches of slop oils are purified in the same system.

Small water droplets are hard to remove from oil. For example, disc stack centrifugal separators are more effective for removing water droplets above a certain size. This size is dependent on for example both the centrifugal separator itself and on the viscosity of the oil. Small water droplets are also hard to get rid of in other types of separation devices such as for example filter devices and settling tanks.

Mixing devices are often used in oil purification systems for example for mixing of contaminated oil and a separation aid. In these mixing devices there may be a risk that water (heavy phase) present in the contaminated oil is turned into small droplets of water which are hard to separate from the oil.

### SUMMARY

An object of the present invention is to provide an improved method and system for purification of contaminated oils.

A further object of the invention is to provide a method and system for purification of contaminated oil with an improved mixing system.

This is achieved by a method and a system according to the independent claims.

According to one aspect of the invention a method for purification of contaminated oil is provided comprising the steps of:
providing contaminated oil into a mixing system comprising at least two mixers connected in parallel and at least one valve which can be controlled for allowing contaminated oil to enter one or more of the mixers;
mixing the contaminated oil in the mixing system;
forwarding the mixed contaminated oil from the mixing system to a separation device, possibly via one or more other units of the oil purification system;
separating the contaminated oil in the separation device,

wherein the step of mixing comprises:
measuring a pressure difference over at least one of the mixers and/or over the complete mixing system; and
controlling the at least one valve in the mixing system such that the contaminated oil is allowed to enter one or more of the mixers in dependence of the measured pressure difference.

According to another aspect of the invention an oil purification system is provided comprising:
a mixing system comprising an inlet via which contaminated oil which will be purified in the oil purification system can be provided into the mixing system;
a separation device comprising an inlet which is fluidly connected to an outlet of said mixing system, possibly via one or more other units of the oil purification system,
wherein said mixing system comprises at least two mixers connected in parallel and at least one valve which can be controlled for allowing contaminated oil to enter one or more of the mixers, said mixing system further comprising a pressure measuring device comprising at least two pressure sensors which are positioned in the mixing system such that they can measure a pressure difference over at least one of the mixers and/or over the complete mixing system.

Hereby, by connecting one or more of the mixers into the purification system in dependence of a measured pressure difference over at least one of the mixers or over the whole mixing system it can be assured that the pressure difference will not be too high. By connecting more mixers in the mixing system the pressure difference can be kept low while the flow rate through the system can be upheld. A higher pressure difference over a mixer will provide droplets of heavy phase, for example water or salty water, of smaller size, i.e. the higher pressure difference the smaller droplets. Droplets of heavy phase in a contaminated oil are hard to separate from the light phase, i.e. from the oil, when the droplets are smaller than a certain limit. For example, centrifugal separators are effective to remove droplets of a certain size to 100% but less effective for smaller droplets. This is also dependent on for example the viscosity of the oil which can be seen in FIGS. 1a, 1b, 1c. By connecting more mixers in the mixing system for the contaminated oil to be mixed in, a flowrate through the system can be kept and still the droplet sizes of the heavy phase can be kept above a certain lower limit. The alternative, if only one mixer is used, would be to lower the flowrate through the mixer in order to keep a pressure difference below a certain threshold and thereby limit the risk to produce too small heavy phase droplets. However, the advantage with connecting one or more mixers in dependence of the pressure difference is that the flowrate and total system capacity can be upheld.

In one embodiment of the invention the oil purification system further comprises a control system, wherein said control system is provided in communication contact with the pressure measuring device and with the at least one valve and wherein the control system is configured to control the at least one valve such that the contaminated oil is allowed to enter one or more of the mixers in dependence of the measured pressure difference over at least one of the mixers and/or over the complete mixing system.

In one embodiment of the invention said step of controlling the at least one valve in dependence of the measured pressure difference comprises allowing contaminated oil to enter two or more mixers when the measured pressure difference is increasing above a pressure difference threshold. In one embodiment of the invention said control system is configured to control the at least one valve to allow contaminated oil to enter two or more mixers when the measured pressure difference is increasing above a pressure difference threshold. By adding a mixer the pressure difference will decrease below the pressure difference threshold and the sizes of heavy phase droplets will be kept large enough for being effectively separated.

In one embodiment of the invention the step of controlling the at least one valve comprises to control the at least one valve to allow contaminated oil to enter one additional mixer when a measured pressure difference increases above a pressure difference threshold. In one embodiment of the invention said control system is configured to control the at least one valve to allow contaminated oil to enter one additional mixer when a measured pressure difference increases above a pressure difference threshold.

In one embodiment of the invention said step of measuring a pressure difference over at least one of the mixers and/or over the complete mixing system comprises measuring at least two pressures by a pressure measuring device comprising at least two pressure sensors which are positioned in the mixing system such that they can measure a pressure difference over at least one of the mixers and/or over the complete mixing system and wherein the step of controlling the at least one valve in dependence of the measured pressure difference comprises controlling the at least one valve from a control system which is provided in communication contact with the pressure measuring device and the at least one valve.

In one embodiment of the invention the method further comprises the step of adding a separation aid to the contaminated oil before or when the contaminated oil is mixed in the mixing system. In one embodiment of the invention the oil purification system further comprises a separation aid tank which is connected in the system such that separation aid can be added from the separation aid tank to the contaminated oil before it is provided into the mixing system or directly into each of the mixers.

In one embodiment of the invention said mixers are static inline mixers.

In one embodiment of the invention the step of separating the contaminated oil in the separation device comprises centrifuging the contaminated oil, wherein the separation device is a centrifugal separator and whereby a heavy phase and a light phase are retrieved from the centrifugal separator.

In one embodiment of the invention the method further comprises a step of measuring one or more properties in a light phase and/or heavy phase retrieved from a light phase outlet and/or heavy phase outlet of the separation device, wherein said one or more properties comprise one or more of a density, a viscosity, a flow rate, an amount of heavy phase content in the light phase and wherein said step of controlling the at least one valve in the mixing system is further dependent on at least one value of the measured one or more properties. In one embodiment of the invention the oil purification system further comprises at least one sensor positioned in fluid connection with a light phase outlet from the separation device and/or a heavy phase outlet from the separation device, wherein said sensor is configured for measuring one or more properties, wherein said one or more properties comprises one or more of a density, a viscosity, an amount of heavy phase content in the light phase and a flow rate, wherein said at least one sensor is provided in communication contact with the control system and wherein the control system is configured to control the at least one valve in dependence of at least one value of said one or more measured properties.

In one embodiment of the invention the pressure difference threshold is defined in dependence of at least one value of the measured one or more properties. In one embodiment of the invention the control system is configured to define the pressure difference threshold in dependence of at least one value of the measured one or more properties.

### BRIEF DESCRIPTION OF THE DRAWINGS

FIGS. 1a, 1b and 1c show diagrams of a droplet grade efficiency for a centrifugal separator for three different oil viscosities.

FIG. 2 shows schematically an oil purification system according to one embodiment of the invention.

FIG. 3 is a flow chart of a method according to one embodiment of the invention.

### DETAILED DESCRIPTION OF THE EMBODIMENTS

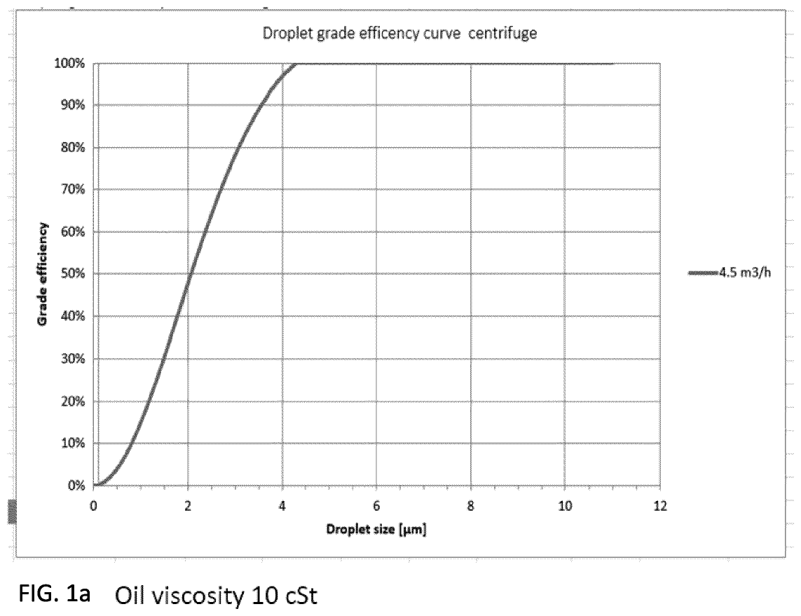

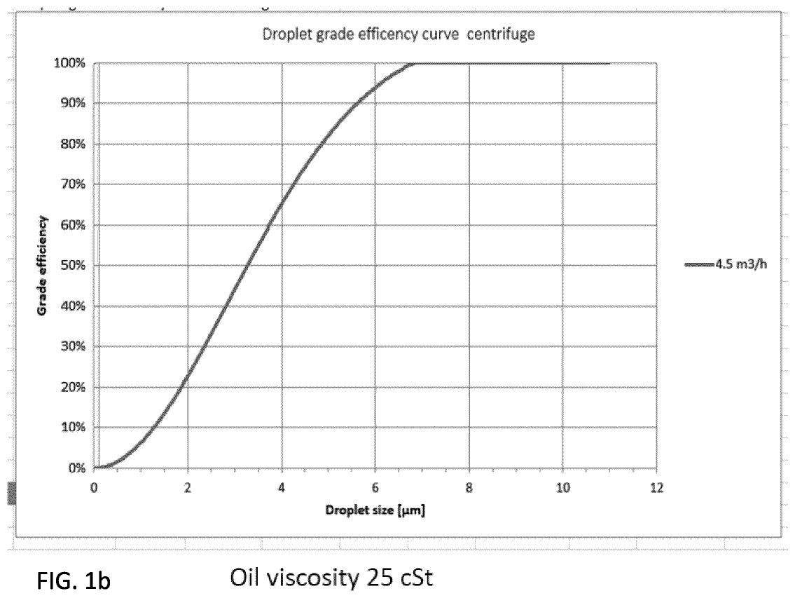

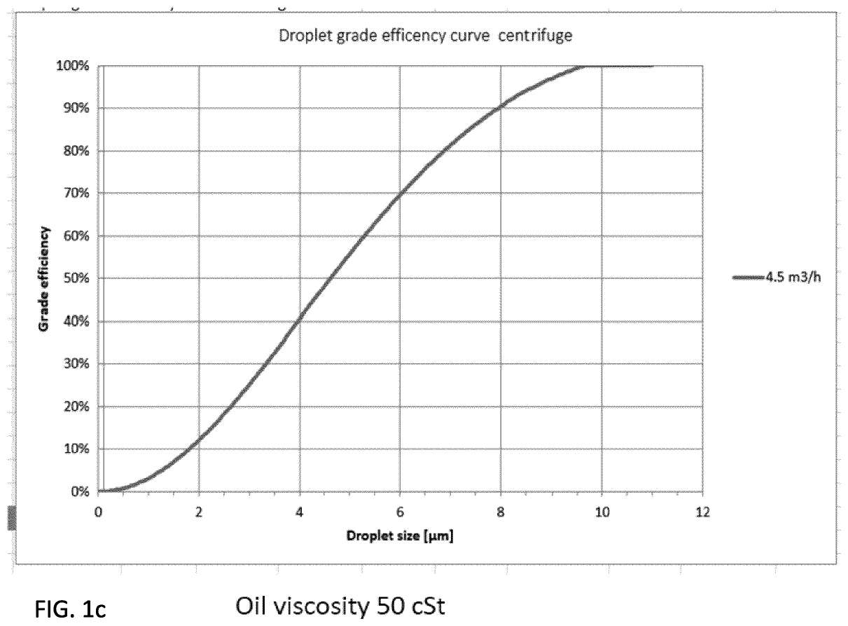

When purifying contaminated oil, such as for example slop oil, waste oil, slurry oil, crude oil, industrial oil, petroleum products or bio-oils, a mix of light phase, a heavy phase and other contaminants need to be separated. The light phase comprises oil of different types and the heavy phase comprises for example water, water comprising salt, such as brine or water with added mono ethylene glycol (MEG). Droplets of heavy phase are often mixed into the light phase and these droplets need to be separated from the light phase. In for example a centrifugal separator, droplets of heavy phase can be separated out. However, the efficiency for removing the droplets is dependent on the size of the droplets. This is also different for different centrifugal separators. It is also dependent on the viscosity of the oil. This is shown in FIGS. 1a, 1b and 1c where diagrams of a droplet grade efficiency for a centrifugal separator for three different oil viscosities, 10 cSt, 25 cSt and 50 cSt are shown. Hereby it is important to keep droplet sizes of the heavy phase above a certain size, i.e. the separation efficiency will be better if the smallest droplet sizes are avoided.

In oil purification systems, mixing devices are often provided, for example for mixing of a separation aid, also called demulsifiers or booster, into the contaminated oil. In a mixing device there is a risk that droplets of heavy phase of different sizes are produced. According to the invention a pressure difference over the mixing device is monitored in order to avoid a too high pressure difference. This is because the sizes of the droplets will be smaller and smaller the higher the pressure difference is over the mixing device. However, a pressure difference threshold to stay below will be dependent on different factors, such as for example the viscosity of the light phase (i.e. the oil), the density of the light phase, the density of the heavy phase, the flow rate through the mixing device and the type of separation device to be used as a next step of purification and possibly also exact settings in this separation device. For example, if a centrifugal separator is used as the next separation device this centrifugal separator will be effective to certain degrees for certain droplet sizes as shown in FIGS. 1a, b and c. Furthermore, feedback information from purification results after a next separation device can be used for setting a proper pressure difference threshold, e.g. a measure of an amount of heavy phase in the retrieved light phase from the separation device can be used for lowering or raising the pressure difference threshold to stay under.

Further according to the invention an additional mixer can be connected in the mixing device when a pressure difference threshold has been reached as measured by a pressure measuring device. Hereby the number of used mixers (connected in parallel) is chosen in dependence of a measured pressure difference over the complete mixing device (comprising all the mixers) or over at least one of the mixers in the mixing device. This is suitable because instead of lowering a flow rate through only one mixer in order to stay below a pressure difference, more mixers are connected and a flow rate can be kept and hereby a capacity of the system can be upheld.

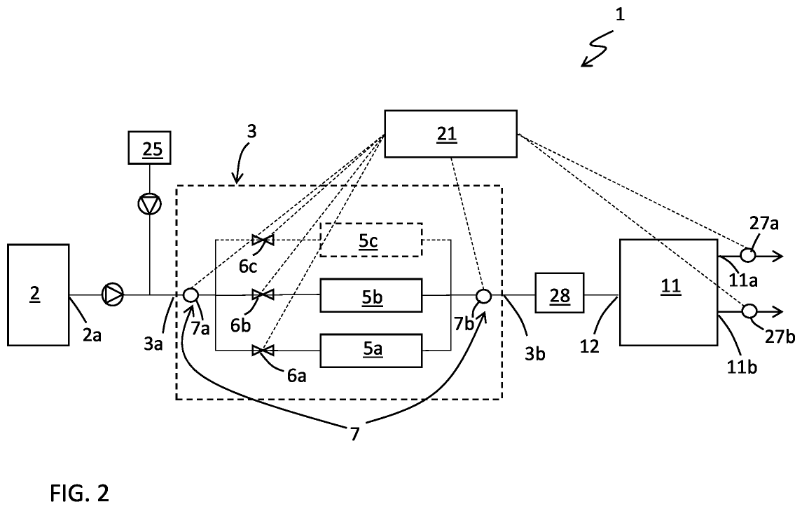

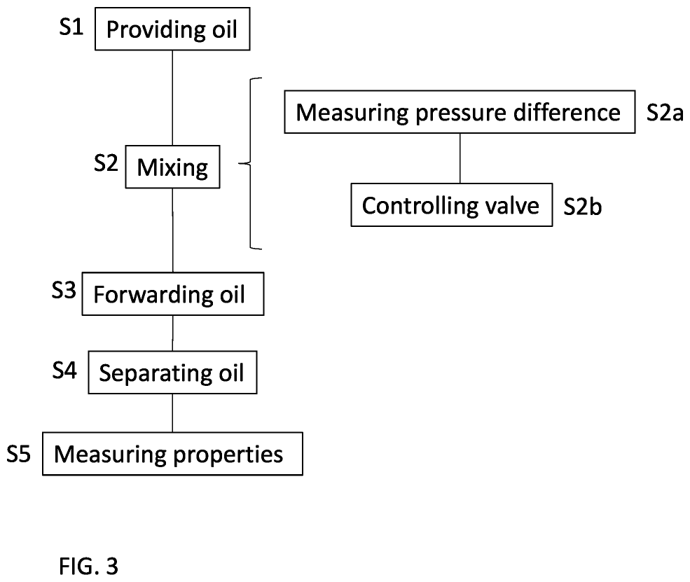

FIG. 2 shows schematically an oil purification system 1 according to one embodiment of the invention. FIG. 3 is a flow chart of a method according to one embodiment of the invention. A description of some embodiments of the invention will now be given with reference to both FIGS. 2 and 3.

An oil purification system 1 is provided comprising a mixing system 3. The mixing system 3 comprises an inlet 3a via which contaminated oil which is purified in the oil purification system can be provided into the mixing system 3. The oil purification system 1 comprises further a separation device 11 comprising an inlet 12 which is fluidly connected to an outlet 3b of said mixing system 3, possibly via one or more other units 28 of the oil purification system. Said other units 28 can for example be one or more buffer tanks, other separation devices such as filtration devices, settling tanks or centrifugal separators, pumps, sensors and other units which may be used in an oil purification system. The mixing system 3 comprises at least two mixers 5a, 5b, 5c connected in parallel. In FIG. 2 an optional third mixer 5c is shown in dotted lines. More than three mixers can also be provided in the mixing system 3. The mixing system 3 comprises also at least one valve 6a, 6b, 6c which can be controlled for allowing contaminated oil to enter one or more of the mixers 5a, 5b, 5c. If only two mixers 5a, 5b are provided one or two valves 6a, 6b may be provided and if three mixers 5a, 5b, 5c are provided two or three valves 6a, 6b, 6c may be provided. Hereby the number of valves may be one less than the number of mixers. However, in FIG. 2 one valve is provided for each of the mixers. However, in some embodiments of the invention contaminated oil can be allowed to always pass through one of the mixers and the other parallel mixers may be connected or not in dependence on a measured pressure difference over the mixing system 3. Hereby one of the valves 6a, 6b, 6c in FIG. 2 may be omitted. The mixing system 3 comprises further a pressure measuring device 7 comprising at least two pressure sensors 7a, 7b which are positioned in the mixing system 3 such that they can measure a pressure difference over at least one of the mixers 5a, 5b, 5c and/or over the complete mixing system 3. In FIG. 2 the pressure measuring device 7 is provided for measuring a pressure difference over the whole mixing system 3. Hereby one pressure is measured at an inlet 3a of the mixing system 3 by an inlet pressure sensor 7a positioned in fluid connection with the inlet 3a of the mixing system 3 and another pressure is measured at an outlet 3b of the mixing system 3 by an outlet pressure sensor 7b positioned in fluid connection with the outlet 3b of the mixing system 3. However, in another embodiment a pressure difference can instead be measured for each of the mixers. In still another embodiment it may be enough to measure the pressure difference over only one of the mixers. If for example only two mixers 5a, 5b are provided the pressure difference over one of the mixers which is always in use can be measured and the other mixer can be connected in dependence of this measured pressure difference.

Hereby an oil purification system is provided where a number of mixers 5a, 5b, 5c are provided in parallel in a mixing system. One or more valves 6a, 6b, 6c are provided such that the mixers can be connected or disconnected for the oil to pass through the mixing system 3. Furthermore, a pressure measuring device is provided such that a pressure difference can be measured over the mixing system 3. The possibility to connect one or more mixers 5a, 5b, 5c is suitable for avoiding a too high pressure difference over the mixing system 3 and thereby avoiding too small droplets of heavy phase to be produced in the mixing system 3 as discussed above. By avoiding the smallest droplets of heavy phase, the light phase and the heavy phase can be more effectively separated in the separation device 11. Small droplets of heavy phase are often hard to separate out completely.

The oil purification system may also comprise a control system 21 which is provided in communication contact with the pressure measuring device 7 and with the at least one valve 6a, 6b, 6c. The control system 21 is configured to control the at least one valve 6a, 6b, 6c such that the contaminated oil is allowed to enter one or more of the mixers 5a, 5b, 5c in dependence of the measured pressure difference over at least one of the mixers 5a, 5b, 5c and/or over the complete mixing system 3.

A method for purification of contaminated oil according to some embodiments of the invention comprises the steps as described in order below:

S1: Providing contaminated oil into a mixing system 3 comprising at least two mixers 5a, 5b, 5c connected in parallel and at least one valve 6a, 6b, 6c which can be controlled for allowing contaminated oil to enter one or more of the mixers 5a, 5b, 5c.

S2: Mixing the contaminated oil in the mixing system 3. The step of mixing S2 comprises:

S2a: Measuring a pressure difference over at least one of the mixers 5a, 5b, 5c and/or over the complete mixing system 3. Said step comprises in some embodiments to measure at least two pressures by a pressure measuring device 7 comprising at least two pressure sensors 7a, 7b as described above. The control system 21 is hereby in communication contact with the inlet pressure sensor 7a and the outlet pressure sensor 7b and is configured to compare the pressure at the inlet 3a and the pressure at the outlet 3b for arriving at the pressure difference.

The step of mixing comprises further:

S2b: Controlling the at least one valve 6a, 6b, 6c in the mixing system 3 such that the contaminated oil is allowed to enter one or more of the mixers 5a, 5b, 5c in dependence of the measured pressure difference. Said step of controlling the at least one valve 6a, 6b, 6c in dependence of the measured pressure difference can in some embodiments comprise to allow contaminated oil to enter two or more mixers 5a, 5b, 5c when the measured pressure difference is increasing above a pressure difference threshold. In some embodiments of the invention the step of controlling the at least one valve 6a, 6b, 6c comprises to control the at least one valve 6a, 6b, 6c to allow contaminated oil to enter one additional mixer (5b, 5c) when a measured pressure difference increases above a pressure difference threshold. Hereby, only one mixer 5a can be used initially as long as the measured pressure difference is below the pressure difference threshold and when the measured pressure difference increases above said pressure difference threshold one additional mixer 5b is connected for the oil to pass. Hereby the pressure difference will decrease. As long as the measured pressure difference is kept below the pressure difference threshold the two mixers 5a, 5b are used but if the measured pressure difference increases once again above the pressure difference threshold one additional mixer 5c can be connected and so on. In the same way, a mixer can be disconnected if the measured pressure difference decreases below another pressure difference threshold, here called a lower pressure difference threshold. The lower pressure difference threshold is lower than the pressure difference threshold. In some embodiments of the invention more different pressure difference thresholds may be used for controlling connection and disconnection of the mixers 5a, 5b, 5c. The step of controlling the at least one valve 6a, 6b, 6c in dependence of the measured pressure difference comprises controlling the at least one valve 6a, 6b, 6c from the control system 21 which is provided in communication contact with the pressure measuring device 7 and the at least one valve 6a, 6b, 6c.

S3: Forwarding the mixed contaminated oil from the mixing system 3 to a separation device 11, possibly via one or more other units 28 of the oil purification system.

S4: Separating the contaminated oil in the separation device 11.

In some embodiments of the invention the method further comprises the step of:

S5: Measuring one or more properties in a light phase and/or heavy phase retrieved from a light phase outlet 11a and/or heavy phase outlet 11b of the separation device 11, wherein said one or more properties comprise one or more of a density, a viscosity, a flow rate, an amount of heavy phase content in the light phase and wherein said step of controlling S2b the at least one valve 6a, 6b, 6c in the mixing system 3 is further dependent on at least one value of the measured one or more properties.

Hereby, the oil purification system 1 in some embodiments comprises at least one sensor 27a, 27b positioned in fluid connection with a light phase outlet 11a from the separation device 11 and/or a heavy phase outlet 11b from the separation device 11, wherein said sensor 27a, 27b is configured for measuring one or more properties, wherein said one or more properties comprises one or more of a density, a viscosity, an amount of heavy phase content in the light phase and a flow rate. Said at least one sensor 27a, 27b is provided in communication contact with the control system 21 and the control system 21 is configured do control the at least one valve 6a, 6b, 6c in dependence of at least one value of said one or more measured properties.

In some embodiments of the invention the one or more pressure difference thresholds are defined in dependence of at least one value of the measured one or more properties. Hereby different pressure difference thresholds are defined depending on at least one of the measured properties. The control system 21 is configured to define the one or more pressure difference thresholds in dependence of at least one value of the measured one or more properties.

For example, a pressure difference threshold can be defined based on a measured viscosity of the light phase retrieved from the light phase outlet 11a from the separation device 11. If the light phase is measured to have a comparatively low viscosity the pressure difference threshold can be set to be comparatively high, i.e. only one mixer is needed for pressure differences measured to be below said pressure difference threshold. If a viscosity of the light phase is measured to be higher than a certain threshold, the pressure difference threshold needs to be set lower than for the lower viscosity oil. I.e. more mixers are needed even for lower pressure differences. A correspondence between density of the light phase retrieved from the light phase outlet 11a and the pressure difference threshold to be set can be the same, i.e. a higher density of the light phase would need a lower pressure difference threshold before more mixers are connected in the mixing system. This is due to the separability grade change of the separation device 11 were decreased density difference between heavy phase and light phase means that droplets need to be larger (separability gets worse). The opposite is also valid meaning increased density difference gives higher pressure difference threshold (separability increases). Flow rate increase gives a decreased retention time inside separation device 11 which means that droplets need to be larger (separability gets worse) to obtain the same output results. The change of performance can be detected by the water (heavy phase) in oil (light phase) measurement on the light phase outlet. The control system 21 is hereby configured for combining the information received from the at least one sensor 27a, 27b provided in fluid connection with the light phase outlet 11a and/or the heavy phase outlet 11b from the separation device 11 into at least one pressure difference threshold. The at least one pressure difference threshold will hereby have different values for different contaminated oils to be purified and are calculated for each purification process or can even be continually updated during the purification process if measurements of the parameters are changed during purification.

The method comprises furthermore in some embodiments of the invention a step of adding a separation aid to the contaminated oil before or when the contaminated oil is mixed in the mixing system 3. The oil purification system 1 may hereby also comprise a separation aid tank 25 which is connected in the system such that separation aid can be added from the separation aid tank 25 to the contaminated oil before it is provided into the mixing system 3 or directly into each of the mixers 5a, 5b, 5c. The separation aid can be for example a demulsifier.

The mixers 5a, 5b, 5c are in some embodiments of the invention static inline mixers. Other types of mixers which can be used are for example laminar and turbulent static mixers, a mixing pump or a pipe restriction creating pressure drop. The static inline mixers 5a, 5b, 5c are designed for providing a controlled minimum droplet size. The mixers 5a, 5b, 5c can be designed specifically for the used separation device 11 such that the sizes of the droplets produced in the mixers 5a, 5b, 5c are effectively separated in the separation device 11. If the separation device for example is a centrifugal separator the size of the droplets produced in the mixers should suitably be kept above a droplet size which this centrifugal separator will separate at 100%. The droplet size efficiency for a centrifugal separator is for example dependent on density difference between heavy phase and light phase and oil viscosity which is shown in FIGS. 1a, 1b, and 1c with focus on the viscosity change and the separability.

In some embodiments of the invention the separation device 11 is a centrifugal separator. Hereby the contaminated oil is centrifuged in the separation device 11 whereby a heavy phase and a light phase are retrieved from the centrifugal separator 11. Other examples of separation devices 11 which can be used in the oil purification device according to the invention are settling tanks, filter devices, electrostatic coalescers, coalescer filters, or FWKO drum.

1. A method for purification of contaminated oil comprising the steps of:
providing contaminated oil into a mixing system including at least two mixers connected in parallel and at least one valve configured to be controlled to allow contaminated oil to enter one or more of the mixers;
mixing the contaminated oil in the mixing system;
forwarding the mixed contaminated oil from the mixing system to a separation device; and
separating the contaminated oil in the separation device,
wherein the step of mixing comprises:
measuring a pressure difference over at least one of the mixers and/or over the complete mixing system; and
controlling the at least one valve in the mixing system such that the contaminated oil is allowed to enter one or more of the mixers depending on the measured pressure difference.

2. The method according to claim 1, wherein the step of controlling the at least one valve depending on the measured pressure difference includes allowing contaminated oil to enter two or more mixers when the measured pressure difference is above a pressure difference threshold.

3. The method according to claim 1, wherein the step of controlling the at least one valve includes controlling the at least one valve to allow contaminated oil to enter one additional mixer when a measured pressure difference increases above a pressure difference threshold.

4. The method according to claim 1, wherein the step of measuring a pressure difference over at least one of the mixers and/or over the complete mixing system includes measuring at least two pressures by a pressure measuring device including at least two pressure sensors positioned in the mixing system such that each pressure sensor measures a pressure difference over at least one of the mixers and/or over the complete mixing system and wherein the step of controlling the at least one valve depending on the measured pressure difference includes controlling the at least one valve using a control system communicatively connected with the pressure measuring device and with the at least one valve.

5. The method according to claim 1, further comprising a step of adding a separation aid to the contaminated oil before or when the contaminated oil is mixed in the mixing system.

6. The method according to claim 1, wherein the step of separating the contaminated oil in the separation device includes centrifuging the contaminated oil, wherein the separation device is a centrifugal separator and whereby a heavy phase and a light phase are retrieved from the centrifugal separator.

7. The method according to claim 1, further comprising a step of measuring one or more properties in a light phase retrieved from a light phase outlet of the separation device and/or in a heavy phase retrieved from a heavy phase outlet of the separation device, wherein the one or more properties include one or more of a density, a viscosity, a flow rate, and an amount of heavy phase content in the light phase and wherein the step of controlling the at least one valve in the mixing system is further dependent on at least one value of the one or more measured properties.

8. The method according to claim 2, wherein the pressure difference threshold is defined using at least one value of the one or more measured properties.

9. An oil purification system comprising:
a mixing system including an inlet for receiving contaminated oil to be purified in the oil purification system and an outlet; and
a separation device including an inlet fluidly connected to the outlet of the mixing system,
wherein the mixing system includes at least two mixers connected in parallel and at least one valve configured to be controlled to allow contaminated oil to enter one or more of the at least two mixers, the mixing system further including a pressure measuring device with at least two pressure sensors positioned in the mixing system such that the at least two sensors measure a pressure difference over at least one of the mixers and/or over the entire mixing system.

10. The oil purification system according to claim 9, further comprising a control system communicatively connected with the pressure measuring device and with the at least one valve and wherein the control system is configured to control the at least one valve such that the contaminated oil is allowed to enter one or more of the mixers depending on the measured pressure difference over at least one of the mixers and/or over the complete mixing system.

11. The oil purification system according to claim 10, wherein the control system is configured to control the at least one valve to allow contaminated oil to enter two or more mixers when the measured pressure difference is above a pressure difference threshold.

12. The oil purification system according to claim 10, wherein the control system is configured to control the at least one valve to allow contaminated oil to enter one additional mixer when a measured pressure difference is above a pressure difference threshold.

13. The oil purification system according to claim 9, further comprising a separation aid tank connected in the system such that a separation aid from the separation aid tank is added to the contaminated oil before the contaminated oil enters the mixing system or is added directly into each of the mixers.

14. The oil purification system according to claim 9, wherein the mixers are static inline mixers.

15. The oil purification system according to claim 9, wherein the separation device is a centrifugal separator.

16. The oil purification system according to claim 10, further comprising at least one sensor positioned in fluid connection with a light phase outlet of the separation device and/or a heavy phase outlet of the separation device, wherein the at least one sensor is configured to measure one or more properties, wherein the one or more properties includes one or more of a density, a viscosity, an amount of heavy phase content in the light phase and a flow rate, wherein the at least one sensor is communicatively connected with the control system and wherein the control system is configured to control the at least one valve depending on at least one value of the one or more measured properties.

17. The oil purification system according to claim 11, wherein the control system is configured to define the pressure difference threshold in using at least one value of the one or more measured properties.

18. The method according to claim 1, wherein the mixing system is connected to the separation device by one or more of a buffer tank, a filtration device, a settling tank, a centrifugal separator, a pump or a sensor.

19. The oil purification according to claim 9, wherein the outlet of the mixing system is connected with the inlet of the separation device by one or more of a buffer tank, a filtration device, a settling tank, a centrifugal separator, a pump or a sensor.
